(19) United States
(12) Patent Application Publication
(10) Pub. No.: US 2026/0045824 A1
(43) Pub. Date: Feb. 12, 2026

(54) INFORMATION PROCESSING DEVICE, INFORMATION PROCESSING SYSTEM, INFORMATION PROCESSING METHOD, AND COMPUTER PROGRAM

(71) Applicant: GS Yuasa International Ltd., Kyoto-shi, Kyoto (JP)

(72) Inventors: Keita NAKAI, Kyoto-shi, Kyoto (JP); Hitoshi MATSUSHIMA, Kyoto-shi, Kyoto (JP)

(21) Appl. No.: 18/852,374

(22) PCT Filed: Mar. 27, 2023
(86) PCT No.: PCT/JP2023/012144

§ 371 Date: Apr. 1, 2025

(30) Foreign Application Priority Data
Mar. 31, 2022 (JP) 2022-060632

(51) Int. Cl. H02J 13/00

(52) U.S. Cl. CPC H02J 13/00002; H02J 13/00001; H02J 13/00006

(57) ABSTRACT

An information processing device includes: an acquisition unit that acquires state data indicating a state of a monitoring target device from a communication device of the monitoring target device, which is an energy storage device or a power supply related device, or from a communication device of a system including a plurality of the monitoring target devices by communication; a storage processing unit that stores the acquired state data in a storage medium in association with identification data of the monitoring target device or the system; and a transmission processing unit that transmits, in response to a request from an outside or as an event, display information collectively displaying the state data stored in the storage medium and a communication state with the communication device while the state data and the communication state are distinguished from each other for each monitoring target device or system.

### TECHNICAL FIELD

The present invention relates to an information processing device, an information processing system, an information processing method, and a computer program that receive information about an energy storage device and/or a power supply related device.

### BACKGROUND ART

Utilization of the energy storage device in a large-scale system that temporarily stores electric power generated using renewable energy or electric power generated by an existing power generating system is expanding.

Maintenance activities for supporting stable operation of the system including execution of state diagnosis of the energy storage device, estimation of a state of charge (SOC), or prediction of a life are important in a system using the energy storage device. The maintenance activities are required not only for the energy storage device but also for power supply related devices such as a power conditioning system, an uninterruptible power system, and a rectifier that cooperate with the energy storage device. There has been proposed a technique that enables a maintenance worker to remotely acquire (remotely monitor) states of the energy storage device and the power supply related device included in the system through a server device (see Patent Document 1).

### PRIOR ART DOCUMENT

### Patent Document

Patent Document 1: JP-A-2019-115215

### SUMMARY OF THE INVENTION

### Problems to be Solved by the Invention

The utilization of the system using the energy storage device is expanded, and systems or devices that are handled by the maintenance worker are diversified. In a case where an abnormality or some event requiring attention is predicted in a monitoring target system, improvement is required such that the maintenance worker can quickly grasp where a problem is generated in the system or the monitoring target device from a remote place before the maintenance worker goes to a site and performs a detailed investigation.

One aspect of the present invention provides an information processing device, an information processing system, an information processing method, and a computer program that enable easy recognition of the monitoring target system or monitoring target device where the problem is generated.

### Means for Solving the Problems

An information processing device according to one aspect of the present invention includes: an acquisition unit that acquires state data indicating a state of a monitoring target device from a communication device of the monitoring target device, which is an energy storage device or a power supply related device, or from a communication device of a system including a plurality of the monitoring target devices by communication; a storage processing unit that stores the acquired state data in a storage medium in association with identification data of the monitoring target device or the system; and a transmission processing unit that transmits, in response to a request from an outside or as an event, display information collectively displaying the state data stored in the storage medium and a communication state with the communication device while the state data and the communication state are distinguished from each other for each monitoring target device or system.

### BRIEF DESCRIPTION OF THE DRAWINGS

FIG. 1 is a view illustrating an outline of a remote monitoring system.

FIG. 2 is a view illustrating an example of a hierarchical structure of an energy storage module group and a connection form of a communication device.

FIG. 3 is a block diagram illustrating an internal configuration of a device included in the remote monitoring system.

FIG. 4 is a flowchart illustrating an example of processing in the communication device.

FIG. 5 is a flowchart illustrating an example of a procedure of data processing in a server device.

FIG. 6 is a flowchart illustrating an example of an information processing procedure in the server device.

FIG. 7 is a flowchart illustrating an example of a processing procedure of information presentation from the server device to a client device.

FIG. 8 is a flowchart illustrating the example of the processing procedure of the information presentation from the server device to the client device.

FIG. 9 is a view illustrating a function of an automatic monitor unit.

FIG. 10 is a view illustrating a specific example of a web page presented by the server device.

FIG. 11 is a view illustrating a specific example of the web page presented by the server device.

FIG. 12 is a view illustrating a specific example of the web page presented by the server device.

FIG. 13 is a view illustrating a specific example of the web page presented by the server device.

FIG. 14 is a view illustrating a specific example of the web page presented by the server device.

FIG. 15 is a flowchart illustrating an example of an information processing procedure in a server device according to a second embodiment.

FIG. 16 is a view illustrating a specific example of a web page presented by the server device.

### MODE FOR CARRYING OUT THE INVENTION

An information processing device according to one embodiment of the present invention includes: an acquisition unit that acquires state data indicating a state of a monitoring target device from a communication device of the monitoring target device, which is an energy storage device or a power supply related device, or from a communication device of a system including a plurality of the monitoring target devices by communication; a storage processing unit that stores the acquired state data in a storage medium in association with identification data of the monitoring target device or the system; and a transmission processing unit that transmits, in response to a request from an outside or as an event, display information collectively displaying the state data stored in the storage medium and a communication state with the communication device while the state data and the communication state are distinguished from each other for each monitoring target device or system.

The energy storage device may be a lithium ion battery or a lead-acid battery, but is not limited thereto, and may be another secondary battery, a primary battery, or a capacitor.

The energy storage device may be an energy storage cell or an energy storage module in which a plurality of energy storage cells are connected in series and/or in parallel. The energy storage device may be an energy storage unit (hereinafter, also referred to as “bank”) in which a plurality of energy storage modules are connected in series. The energy storage device may be an energy storage unit (hereinafter, also referred to as “domain”) in which the plurality of energy storage modules or banks are connected in parallel.

The power supply related device may be any of a power conditioning system, an uninterruptible power system, a rectifier, a DC power supply, a charger and a charger and discharger for an electric vehicle.

The information processing device may be a system including a plurality of energy storage devices or power supply related devices as monitoring targets, or may be an energy storage system including only the energy storage devices as monitoring targets. In the information processing device, the monitoring target may be only the power supply related device, or may be the system including the plurality of energy storage devices and the power supply related device.

In the above configuration, information distinguishing and displaying whether the state is the state detected in the monitoring target device or the monitoring target device included in the system or the communication state detected between the monitoring target device and the information processing device is obtained based on the state obtained from the communication device of the monitoring target device or the communication device of the system.

With the above configuration, even when a large number of systems or monitoring target devices are set as monitoring targets, a maintenance worker who visually recognizes a screen displayed based on the display information can collectively grasp each state while recognizing where the state is indicated for each system or monitoring target device.

In the information processing device, the acquisition unit may acquire the measurement data of each of the monitoring target devices. The information processing device may further include an analysis processing unit that analyzes presence or absence of an abnormality or a sign of the abnormality of the monitoring target device or system by an algorithm for each monitoring target device or system based on acquired measurement data. The transmission processing unit may transmit display information, which displays an analysis result by the analysis processing unit while the state data and the communication state are distinguished from each other, for each monitoring target device or system.

In the above configuration, the information processing device estimates the state by analysis of the information processing device itself that accumulates not only the state data obtained by communication from the communication device of the monitoring target device but also the measurement data measured by the monitoring target device. The information processing device can distinguish and display the state detected in the monitoring target device, the communication state, and the analysis result.

With the above configuration, the maintenance worker can grasp the state while distinguishing the state obtained by the monitoring target device from the analysis result estimating the abnormality and the sign of the abnormality.

The display information may be information distinguishing and displaying an analysis result for any monitoring target device included in the monitoring target device or system.

According to the above configuration, the maintenance worker can grasp, for each system or monitoring target device, in which target included in the system or monitoring target device the state is detected. For example, the abnormality is not detected in the lithium ion battery management device itself, but whether the sign of the abnormality is detected can be previously and visually distinguished by the analysis result, so that the maintenance worker can determine maintenance activity to be performed, and efficient maintenance activity can be expected.

The display information may be information distinguishing at which portion included in the monitoring target device or system the state is detected, and displaying the state of the monitoring target device or system.

In the above configuration, the maintenance worker can grasp, for each system or each monitoring target device, either the state detected in which energy storage device or monitoring target device included in the system or monitoring target device or the communication state. Whether the abnormality is detected in the lead-acid battery or the abnormality is detected in the lithium ion battery can be previously and visually distinguished, so that the maintenance worker can determine the maintenance activity to be performed, and the efficient maintenance activity can be expected.

The display information may be information collectively displaying a graphic visually indicating the state data and the communication state at a corresponding portion of a list of the monitoring target devices or systems.

In the above configuration, the state and the communication state are displayed graphically corresponding to each monitoring target device or system, so that the maintenance worker can visually and easily grasp the state and the communication state.

The display information may include information transitioning to a screen that displays detailed information about a part included in the monitoring target device or system, or about the monitoring target device according to a hierarchical structure of the monitoring target device or system for each monitoring target device or system.

In the above configuration, the display information indicating the state of which portion includes information that can transition to a screen displaying detailed information of the system or monitoring target device according to the hierarchy. Thus, the maintenance worker can grasp the state of the system or monitoring target device while roughly distinguishing the place, and then can grasp what state is actually at which portion of the system or the monitoring target device.

An information processing device includes: an acquisition unit that acquires state data indicating a state of a monitoring target device from a communication device of the monitoring target device, which is an energy storage device or a power supply related device, or from a communication device of a system including a plurality of the monitoring target devices by communication; and a transmission processing unit that transmits, in response to a request from the outside or as an event, for each of the monitoring target devices or systems, display information displaying a communication state between the information processing device and the communication device and a communication state between the communication device and the monitoring target device while the communication state between the information processing device and the communication device and the communication state between the communication device and the monitoring target device are distinguished from each other.

In the above configuration, the information that can distinguish and display whether the state indicates the communication state between the information processing device itself and the communication device or the communication state between the communication device and the monitoring target device is obtained based on the state obtained from the communication device of the monitoring target device or the communication device of the system.

An information processing system includes: a plurality of communication devices that are mounted on or connected to a monitoring target device, which is an energy storage device or a power supply related device, or a system including a plurality of monitoring target devices; an information processing device that is capable of establishing communication connection with the plurality of communication devices; and a client device that includes a display unit capable of establishing communication connection with the information processing device. The information processing device sequentially acquires state data indicating a state of the monitoring target device from the plurality of communication devices, stores the acquired state data in a storage medium in association with identification data of the monitoring target device or system, creates display information collectively displaying the state data stored in the storage medium and a communication state with the communication device in response to a request from an outside or as an event while distinguishing the state data and the communication state for each monitoring target device or system, and transmits the created display information to the client device.

An information processing method includes: sequentially acquiring state data indicating a state of a monitoring target device from a communication device of the monitoring target device, which is an energy storage device or a power supply related device, or from a communication device of a system including a plurality of the monitoring target devices by communication; storing the acquired state data in a storage medium in association with identification data of the monitoring target device or the system; and transmitting, in response to a request from an outside or as an event, display information collectively displaying the state data stored in the storage medium and a communication state with the communication device while distinguishing the state data and the communication state for each monitoring target device or system.

A computer program causing a computer capable of establishing communication connection with a communication device of a monitoring target device, which is an energy storage device or a power supply related device, or with a communication device of a system including a plurality of the monitoring target devices by communication to execute: acquiring sequentially state data indicating a state of the monitoring target device from the communication device of the monitoring target device or the communication device of the system; storing the acquired state data in a storage medium in association with identification data of the monitoring target device or system; and transmitting, in response to a request from an outside or as an event, display information collectively displaying the state data stored in the storage medium and a communication state with the communication device while distinguishing the state data and the communication state from each other for each monitoring target device or system.

The present invention will be specifically described with reference to the drawings illustrating embodiments.

### First Embodiment

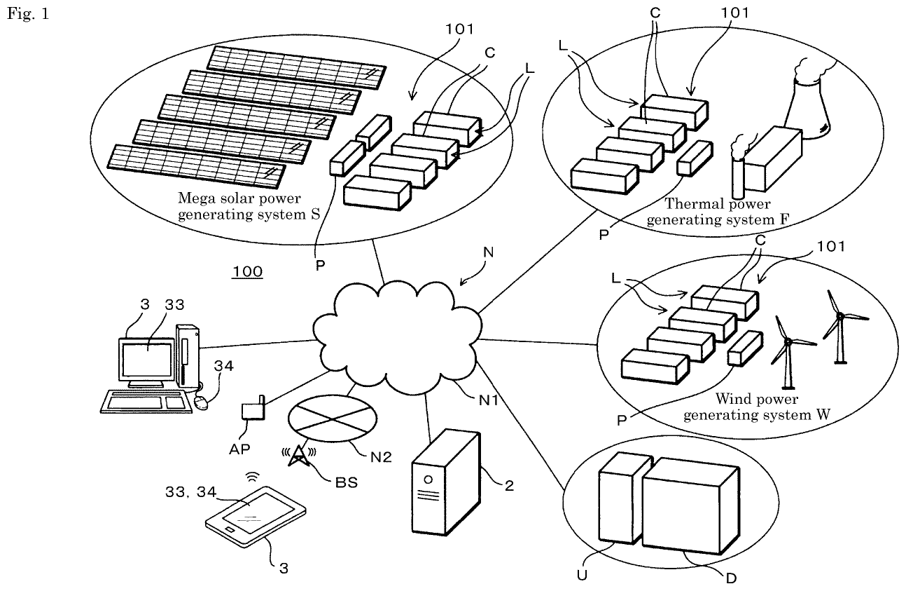

FIG. 1 is a view illustrating an outline of a remote monitoring system 100. The remote monitoring system 100 enables remote access to information about energy storage devices and power supply related devices included in a mega solar power generating system S, a thermal power generating system F, and a wind power generating system W. An uninterruptible power system (UPS) U, a rectifier (DC power supply) D disposed in a stabilized power system, or the like may be remotely monitored.

A power conditioning system (PCS) P and an energy storage system 101 are provided in parallel in the mega solar power generating system S, the thermal power generating system F, and the wind power generating system W. The energy storage system 101 may be configured by arranging a plurality of containers C accommodating an energy storage module group L in parallel. In the energy storage system 101, the energy storage module group L and the power conditioning system P may be disposed in a building (energy storage chamber). The energy storage module group L includes a plurality of energy storage devices. The energy storage device is preferably a secondary battery such as a lead acid battery and a lithium ion battery or a rechargeable capacitor. A part of the energy storage device may be a non-rechargeable primary battery.

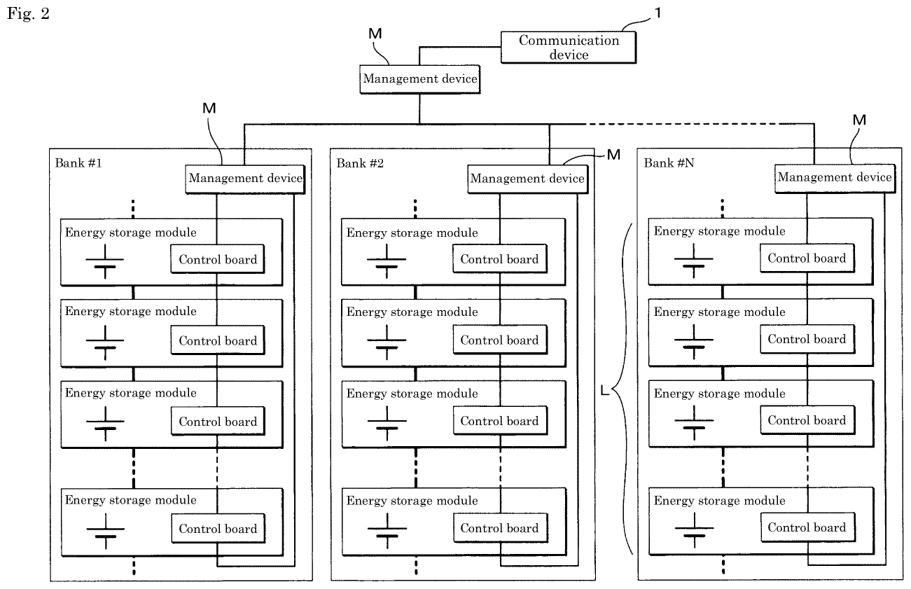

In the remote monitoring system 100, a communication device 1 (see FIG. 2) is mounted on or connected to each of the energy storage system 101 or the power supply related device (P, U, D and a management device M to be described later) in the systems S, F, W that become a monitoring target. The remote monitoring system 100 includes the communication device 1, a server device 2 (information processing device: wording in claims) that collects information from the communication device 1, a client device 3 that browses the collected information, and a network N that is a communication medium between the devices.

The communication device 1 may be a terminal device (measurement monitor) that communicates with a battery management unit (BMU) included in the energy storage device to receive information about the energy storage device, or may be an ECHONET/ECHONETLite (registered trademark) compatible controller. The communication device 1 may be an independent device or a network card type device that can be mounted on the power conditioning system P or the energy storage module group L. For example, the communication device 1 is an independent communication device installed so as to collect state data from a slave device that measures internal resistance, voltage, current, temperature, and the like of the energy storage device that is a lead-acid battery by wireless communication. For example, the communication device 1 is a network card type device that is incorporated in the energy storage apparatus in which lithium ion batteries are connected in series and connected to a control board of the energy storage apparatus.

The communication device 1 is provided for each group including a plurality of energy storage modules in order to acquire information about the energy storage module group L in the energy storage system 101. A plurality of power conditioning systems P are connected so as to be able to perform serial communication, and the communication device 1 is connected to a controller of representative one of the power conditioning systems P.

The server device 2 includes a web server function, and presents information obtained from the communication device 1 mounted on or connected to each monitoring target device according to access from the client device 3.

The network N includes a public communication network N1 that is a so-called Internet and a carrier network N2 that implements wireless communication according to a predetermined mobile communication standard. The public communication network N1 includes a general optical line, and the network N includes a dedicated line connected to the server device 2. The network N may include the ECHONET/ECHONETLite compatible network. The carrier network N2 includes a base station BS, and can communicate with the server device 2 from the base station BS through the network N when the client device 3 is a communication terminal. An access point AP is connected to the public communication network N1, and information can be transmitted and received from the access point AP to and from the server device 2 through the network N when the client device 3 is the communication terminal. The communication device 1 mounted on or connected to the systems S, F, W or the independent power supply related devices P, U, D can be communicably connected to the server device 2 or the client device 3 from a network in the system through the public communication network N1 and the network N.

The energy storage module group L of the energy storage system 101 has a hierarchical structure. The communication device 1 that transmits the information about the energy storage devices to the server device 2 acquires the information about the energy storage devices included in the energy storage module group L from the management device M provided in the energy storage module group L. FIG. 2 is a view illustrating an example of the hierarchical structure of the energy storage module group L and a connection form of the communication device 1. For example, the energy storage module group L has the hierarchical structure of a bank in which a plurality of power storage cells (also referred to as cells) are connected in series and a domain in which a plurality of banks are connected in parallel.

In the example of FIG. 2, one management device M is provided for each of the banks numbered (#) 1 to N and the domain in which the banks are connected in parallel. The management device M provided for each bank communicates with a control board (cell monitoring unit (CMU)) with a communication function built in each energy storage module by serial communication to acquire measurement data (, current, voltage, temperature, internal resistance, and the like) of the energy storage cell in the energy storage module. The management device M of the bank executes management processing such as detection of an abnormality in a communication state with the control board in the communication module and detection of a voltage abnormality of each cell. Each of the management devices M of the banks transmits the measurement data obtained from the energy storage module of each bank to the management device M provided in the domain. The management device M of the domain aggregates information such as the measurement data obtained from the management device M of the bank belonging to the domain and the detected abnormality. In the example of FIG. 2, the communication device 1 is connected to the management device M of the domain. Alternatively, the communication device 1 may be connected to each of the management device M of the domain and the management device M of the bank.

In the remote monitoring system 100, the server device 2 uses the communication device 1 mounted on or connected to each device to collect information such as a state such as an SOC and a state of health (SOH) in the energy storage system 101, an abnormality detected in the power supply related device itself, and an abnormality detected in the communication device 1. Based on the collected state, the server device 2 can derive and present the state of the monitoring target device included in the energy storage system 101 by an algorithm suitable for each system and device based on the accumulated measurement data in addition to the detected abnormality.

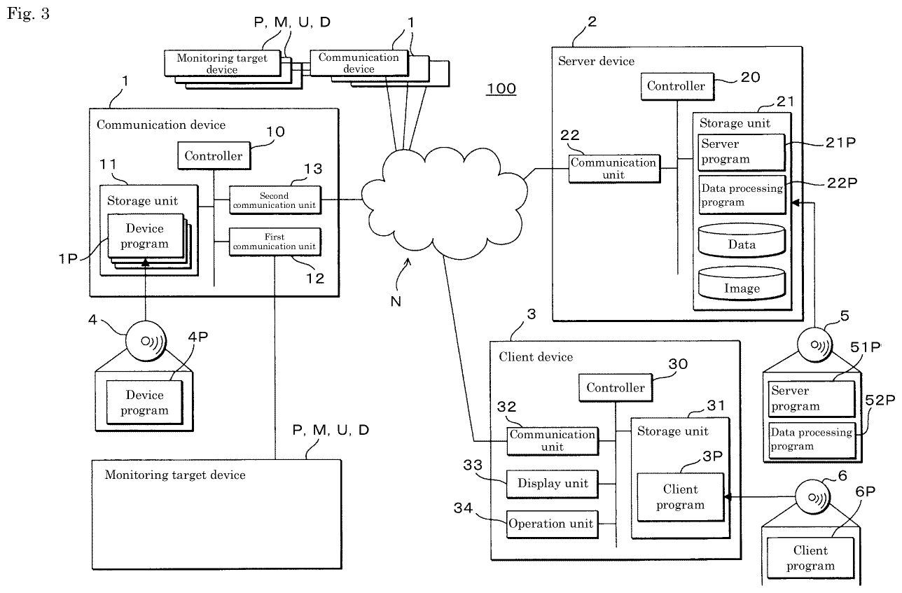

FIG. 3 is a block diagram illustrating an internal configuration of the device included in the remote monitoring system 100. As illustrated in FIG. 3, the communication device 1 includes a controller 10, a storage unit 11, a first communication unit 12, and a second communication unit 13. The controller 10 is a processor using a central processing unit (CPU), and executes processing by controlling each component using a built-in memory such as a read only memory (ROM) and a random access memory (RAM).

The storage unit 11 uses a non-volatile memory such as a flash memory. The storage unit 11 stores a device program 1P read and executed by the controller 10. The device program 1P includes a communication program conforming to secure shell (SSH), simple network management protocol (SNMP), or the like. The storage unit 11 stores information such as information collected by the processing of the controller 10 and an event log. The information stored in the storage unit 11 can also be read out through a communication interface such as a USB in which a terminal is exposed to a housing of the communication device 1. The device program 1P stored in the storage unit 11 may be obtained by the controller 10 reading a device program 4P stored in the recording medium 4 and copying the device program 4P in the storage unit 11.

The first communication unit 12 is a communication interface that implements communication with the monitoring target device to which the communication device 1 is connected. For example, the first communication unit 12 uses a serial communication interface conforming to RS232C or RS485. For example, the power supply related device such as the power conditioning system P includes a controller having a serial communication function conforming to the RS485, and the first communication unit 12 communicates with the controller. When the control board included in the energy storage module group L is connected by a controller area network (CAN) bus and communication between the control boards is implemented by CAN communication, the first communication unit 12 is a communication interface based on a CAN protocol. The first communication unit 12 may be a communication interface compatible with the ECHONET/ECHONETLite standard.

The second communication unit 13 is an interface that implements communication through the network N, and for example, uses a communication interface such as Ethernet (registered trademark) or a wireless communication antenna. The controller 10 is communicably connectable to the server device 2 through the second communication unit 13. The second communication unit 13 may be a communication interface compatible with the ECHONET/ECHONETLite standard.

In the communication device 1 configured as described above, the controller 10 acquires measurement data of the energy storage device, which is obtained in the device on which the communication device 1 is mounted and connected, through the first communication unit 12. The controller 10 acquires the state data in the case where a state such as an abnormal or attentional state of a device, the abnormal or attentional state of the energy storage device, or the like is detected in the device on which the communication device 1 is mounted and connected. The controller 10 may function as an SNMP agent by reading and executing the program for the SNMP, and may respond to an information request from the server device 2 to transmit the measurement data and the state data when the abnormal or attentional state is detected.

The server device 2 uses a server computer, and includes a controller 20, a storage unit 21, and a communication unit 22. In the first embodiment, the server device 2 will be described as one server computer, but processing may be distributed among a plurality of server computers.

The controller 20 is a processor using a CPU or a graphics processing unit (GPU), and executes processing by controlling each component using a built-in memory such as a ROM and a RAM. The controller 20 executes communication and information processing based on a server program 21P stored in the storage unit 21. The server program 21P includes a web server program, and the controller 20 functions as a web server that executes provision of a web page to the client device 3. The controller 20 collects information from the communication device 1 as an SNMP server based on the server program 21P.

For example, the storage unit 21 uses a non-volatile memory such as a hard disk or a flash memory. The storage unit 21 stores the server program 21P and a data processing program 22P. The server program 21P and the data processing program 22P stored in the storage unit 21 may be obtained by the controller 20 reading a server program 51P and a data processing program 52P stored in the recording medium 5 and copying the server program 51P and the data processing program 52P to the storage unit 21.

The storage unit 21 stores measurement data of the power conditioning system P and the energy storage module group L of the energy storage system 101 that is the monitoring target collected by the processing of the controller 20. In the case where other power supply related devices (the rectifier D, the uninterruptible power system U, and the like) are included in the monitoring target, the measurement data thereof is also stored. The measurement data is associated with identification information (number, symbol) identifying the system or the device. The measurement data of the energy storage module group L is stored according to the domain, the bank, the module, or the cell and the hierarchical structure.

The storage unit 21 stores a plurality of images displaying the states of the energy storage module group L or the power supply related devices P, U, D that are the monitoring target. The plurality of images are stored in the storage unit 21 in association with identification information identifying the energy storage module group L or the power supply related devices P, U, D that are the monitoring target. The plurality of images includes images representing the energy storage module group L or the power supply related devices P, U, D. For example, these images are icons, marks, or illustrations that can identify the type of the energy storage module group L, namely, whether the energy storage module group L is a lead acid battery or a lithium ion battery. The plurality of images are icons, marks, or illustrations that can identify the types of the power supply related devices P, U, D, namely, whether the power conditioning system P, the uninterruptible power system U, or the rectifier D. The plurality of images includes images indicating disposition of the energy storage module group L or the power supply related devices P, U, D. These images are photographs such as an aerial photograph and a satellite photographs, 2D maps, design drawings, CAD drawings, or illustrations. These images may be stored by being uploaded from the client device 3. The position or range of the energy storage module group L or the power supply related devices P, U, D that are the monitoring target in the photograph, the map, the design drawing, the drawing, or the illustration is stored for each image. For example, the information indicating the position or the range is coordinate information corresponding to the image. When the image is the aerial photograph, the satellite photograph, or the map, the image may be latitude and longitude information and information indicating a relative position. The plurality of images stored in the storage unit 21 may include images such as illustrations, icons, and animations that express the states (abnormality/normality/attention) of the energy storage module group L or the power supply related devices P, U, D. In addition to the image displaying the state, the storage unit 21 may store design data, such as a style sheet and a script, which visually outputs the states of the energy storage system 101 and the power supply related devices P, U, D on a web basis.

The communication unit 22 is a device that implements communication connection and transmission and reception of information through the network N. Specifically, the communication unit 22 is a network card compatible with the network N.

The client device 3 is a computer used by an operator such as a manager or a maintenance worker of the energy storage system 101 of power generating systems S, F, W. The client device 3 may be a desktop or laptop personal computer, or a so-called smartphone or tablet communication terminal. The client device 3 includes a controller 30, a storage unit 31, a communication unit 32, a display unit 33, and an operation unit 34.

The controller 30 is a processor using a CPU. The controller 30 causes the display unit 33 to display the web page provided by the server device 2 based on a client program 3P stored in the storage unit 31. The client program 3P is incorporated in the web page provided by a web server function of the server device 2, includes a script temporarily stored in the client device 3 and a web browser program, and is a program displaying a web-based screen based on an operation in the server device 2.

For example, the storage unit 31 uses a nonvolatile memory such as a hard disk or a flash memory. The storage unit 31 stores various programs including the client program 3P. The client program 3P may be obtained by the controller 30 reading a client program 6P stored in the recording medium 6 and copying the client program 6P to the storage unit 31.

The communication unit 32 uses a network card for wired communication, a wireless communication device for mobile communication connected to the base station BS (see FIG. 1), or a wireless communication device compatible with connection to the access point AP (see FIG. 1). The controller 30 can perform communication connection with the server device 2 or the communication device 1 mounted on or connected to each device through the network N by the communication unit 32, or can transmit and receive information.

A display such as a liquid crystal display or an organic electro luminescence (EL) display is used as the display unit 33. By processing based on the client program 3P of the controller 30, the display unit 33 displays the image of the web page provided by the server device 2. The display unit 33 may be a touch panel built-in display or a touch panel non-built-in display.

The operation unit 34 is a keyboard and a pointing device capable of inputting and outputting to and from the controller 30, or a user interface such as a sound input unit. The operation unit 34 may use a touch panel of the display unit 33 or a physical button provided on a housing. The operation unit 34 notifies the controller 30 of operation information by the user.

In the remote monitoring system 100 configured as described above, the server device 2 periodically acquires the state data and the measurement data of the monitoring target system or the monitoring target device from the communication device 1 based on the data processing program 22P, and stores the state data and the measurement data in the storage unit 21 (acquisition unit and storage processing unit). The monitoring target system or the monitoring target device includes any one or a plurality of energy storage system 101 including the energy storage module group L, the power conditioning system P, the uninterruptible power system U, and the rectifier D. The server device 2 stores configuration data indicating the hierarchical structure of the energy storage module group L (domain, bank, module, cell) and/or the power supply related devices P, U, D in the monitoring target system. The configuration data indicating the hierarchical structure may be previously set for each system, or derived from data transmitted from the communication device 1 in a parent-child relationship in which the data are associated with each other. In the case where the power supply related devices P, U, D used alone are monitoring target devices, the server device 2 stores the configuration data indicating that the monitoring target device is used alone. The server device 2 can create screen information visually indicating the state in each layer according to the hierarchical structure of the energy storage module group L (domain, bank, module, cell) and/or the power supply related devices P, U, D in the monitoring target system, and present the screen information in response to a request from the client device 3.

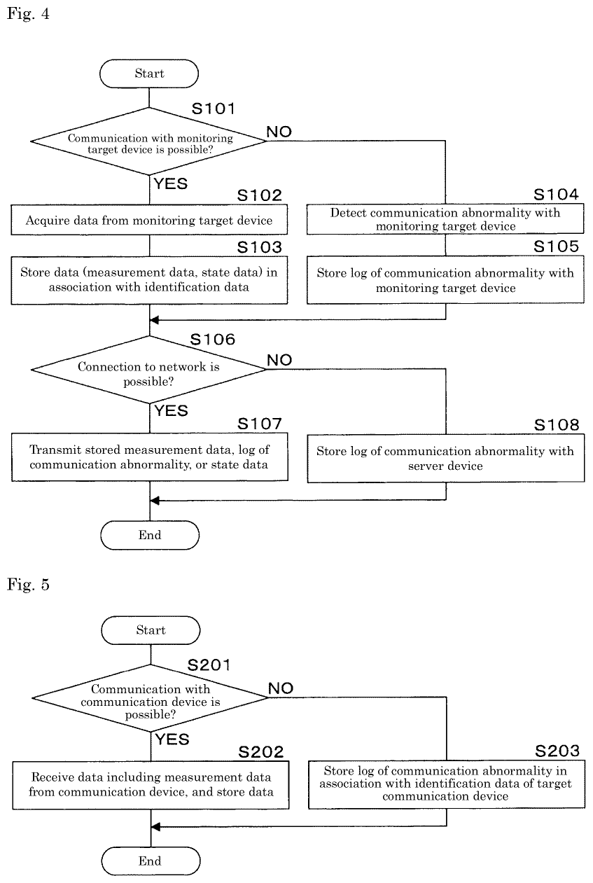

FIG. 4 is a flowchart illustrating an example of processing in the communication device 1. The communication device 1 mounted on or connected to the management device M and other power supply related devices P, U, D repeatedly executes the following processing procedure periodically or in response to a request from the server device 2.

The controller 10 of the communication device 1 determines whether the first communication unit 12 can communicate with the monitoring target device mounted and connected to the controller 10 (step S101). When it is determined that the communication is possible (YES in S101), the controller 10 acquires the data transmitted from the monitor target device (step S102). The controller 10 stores the data in the storage unit 11 in association with identification data identifying which energy storage device the data belongs to (step S103), and advances the processing to step S106.

In step S102, the controller 10 acquires measurement data obtained by the monitoring target device. When the abnormal or attentional state is detected in the monitoring target device, the controller 10 also acquires state data indicating the abnormal or attentional state. The state data includes date and time information when the abnormal state is detected.

When it is determined in step S101 that the communication cannot be performed (NO in S101), the controller 10 detects a communication abnormality between the monitoring target device and the communication device 1 (step S104), stores a log of the communication abnormality with the monitoring target device in association with the identification data identifying the monitoring target device and the date and time information (step S105), and advances the processing to next step S106.

Before the processing of step S105, the controller 10 may determine the abnormal or attentional state of the monitoring target device by the processing by the communication device 1 in the device program 1P based on the acquired measurement data and/or state data. In this case, the controller 10 stores the state data indicating the abnormal or attentional state determined by the communication device 1 in association with the identification data of the monitoring target device and the date and time information.

The controller 10 determines whether the connection to the network N is possible by the second communication unit 13 (step S106). When determining that the connection is possible (YES in S106), the controller 10 transmits the stored measurement data and, if stored, a log or state data of the communication abnormality from the second communication unit 13 to the server device 2 (step S107), and ends processing of one time.

When it is determined that the connection is not possible (NO in S106), the controller 10 stores the log of communication abnormality with the server device 2 (step S108), and ends one process. The log of the communication abnormality stored in step S108 is transmitted together with the measurement data from the monitoring target device stored while the communication is impossible at the timing when the next communication abnormality is recovered in step S107 (recording associated with the date and time information).

In the processing procedure illustrated in the flowchart of FIG. 4, the processing from steps S101 to S104 and the processing from steps S106 to S108 may be independently executed.

The communication device 1 can distinguish and store the result (state data) of determining whether the monitoring target device (energy storage module group L) is in the abnormal or attentional state, the communication abnormality between the monitoring target device and the communication device 1, and the communication abnormality between the communication device 1 and the server device 2, and can transmit the result to the server device 2.

FIG. 5 is a flowchart illustrating an example of a procedure of data processing in the server device 2. The server device 2 periodically executes the following processing on each communication device 1 using information about each monitoring target system or monitoring target device that is periodically acquired from the communication device 1 and stored. The server device 2 may execute the transmission every time the transmission from the communication device 1 is detected.

The controller 20 of the server device 2 determines whether the communication with the target communication device 1 is possible among the plurality of communication devices 1 included in the monitoring target system or the monitoring target device (step S201). In the case where the processing is periodically performed in step S201, the controller 20 determines whether the communication connection can be established by the address of the selected communication device 1 among the plurality of communication devices 1. When detecting the transmission from the communication device 1, the controller 20 determines whether the transmission from the communication device 1 is received at least a predetermined number of times in the past predetermined period.

When it is determined that the communication with the target communication device 1 is possible (YES in S201), the controller 20 receives the data including the measurement data transmitted from the communication device 1, stores the data in the storage unit 21 (step S202), and ends the processing. The processing of step S202 corresponds to the “acquisition unit” and the “storage processing unit”. The measurement data acquired in step S202 is associated with the identification data of the communication device 1 of a transmission source, the identification data of the monitoring target device of the communication device 1, the date and time information, and the like. In step S202, the controller 20 stores the received data along with the identification data thereof.

When it is determined that the communication with the target communication device 1 is not possible (NO in S201), the controller 20 stores the log of the communication abnormality in association with the identification data and the date and time information of the target communication device 1 (step S203), and ends the processing. Steps S202 and S203 correspond to the “storage processing unit”.

According to the processing procedure in FIG. 5, the storage unit 21 of the server device 2 sequentially stores the measurement data, the state data indicating the abnormal or attentional state, the log of the communication abnormality enabling identification of an abnormal portion, and the like, by identifying the communication device 1 of the transmission source. The controller 20 stores configuration data determining to which system or monitoring target device each communication device 1 belongs. For this reason, the detection of the abnormal or attentional state is detected in any one or the plurality of communication devices 1 included in the system or monitoring target device can be determined for each system or monitoring target device.

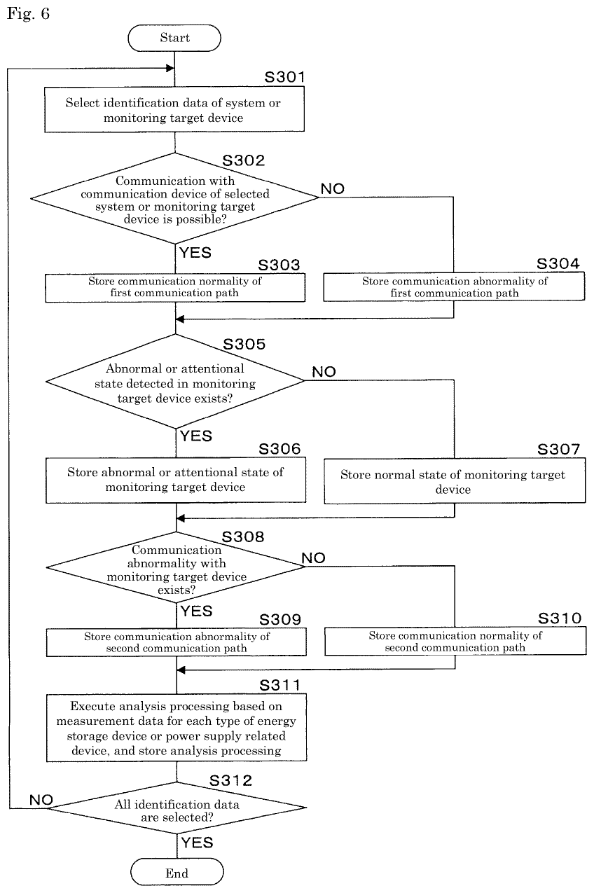

FIG. 6 is a flowchart illustrating an example of an information processing procedure in the server device 2. The server device 2 executes the processing in response to a request from the client device 3 or as an event using the information about each system or monitoring target device acquired from each communication device 1 and stored by the processing procedure in FIG. 5. The event may be the periodic detection, or may be the detection of a state change in each system or monitoring target device such as generation of the abnormality.

The controller 20 selects one piece of identification data identifying the system or the monitoring target device (step S301).

The controller 20 determines whether the communication with the communication device 1 mounted on or connected to the monitoring target device identified by the selected identification data or the monitoring target device included in the system is possible (step S302). When it is determined that the communication is possible (YES in S302), the controller 20 temporarily stores communication normality on a first communication path in association with the identification data selected in step S301 (step S303), and advances the processing to step S305. The first communication path indicates a communication path between the server device 2 and the communication device 1.

When it is determined that the communication is impossible (NO in S302), the controller 20 temporarily stores the communication abnormality in the first communication path in association with the identification data selected in step S301 (step S304), and advances the processing to step S305.

The controller 20 determines whether the abnormal or attentional state detected in the monitoring target device or the monitoring target device included in the system identified by the selected identification data exists (step S305). When receiving the state data indicating the abnormal or attentional state detected in the monitoring target device through the communication device 1, the controller 20 sequentially stores the received state data in the storage unit 21. In step S305, the controller 20 determines whether the state data associated with the date and time information within a predetermined period from the current point of time is stored.

When it is determined that the abnormal or attentional state detected in the monitoring target device exists (YES in S305), the controller 20 temporarily stores the abnormal or attentional state in the monitoring target device in association with the identification data selected in step S301 (step S306), and advances the processing to step S308.

When it is determined that the abnormal or attentional state detected in the monitor target device does not exist (NO in S305), the normal state of the monitoring target device is temporarily stored in association with the identification data selected in step S301 (step S307), and the processing proceeds to step S308.

The controller 20 determines whether the communication abnormality exists between the communication device 1 included in the system or the monitoring target device identified by the selected identification data and the monitoring target device (step S308).

In step S308, in the case where the log (state data) of the abnormal or attentional state detected by the processing of the communication device 1 itself is stored, the controller 20 may also determine that the abnormality exists in this abnormality.

When it is determined that the communication abnormality with the monitoring target device detected in the communication device 1 exists (YES in S308), the controller 20 temporarily stores the communication abnormality in a second communication path in association with the identification data selected in step S301 (step S309), and advances the processing to step S311. The second communication path indicates a communication path between the monitoring target device and the communication device 1.

When it is determined that the communication abnormality with the monitoring target device detected in the communication device 1 does not exist (NO in S308), the controller 20 temporarily stores the communication normality on the second communication path in association with the identification data selected in step S301 (step S310), and advances the processing to step S311.

For the energy storage device or the power supply related device included in the system or the monitoring target device identified by the selected identification data, the controller 20 executes analysis processing based on the measurement data accumulated in the storage unit 21 by the algorithm for each type, and stores the analysis processing (step S311). The analysis processing in step S311 corresponds to the “analysis processing unit”.

In step S311, for example, when the energy storage system 101 included in the system includes the energy storage device that is the lithium ion battery, the controller 20 derives the SOC of the cell for each hierarchy by an algorithm for the lithium ion battery. In the case of the energy storage system 101 having the structure as illustrated in FIG. 2, for example, the hierarchy is the domain, the bank, or the module, and the controller 20 derives not only an SOC in a cell unit but also an SOC in a domain unit, a bank unit, or a module unit. The controller 20 derives a remaining life based on the accumulated measurement data. For example, when the energy storage system 101 included in the system includes the energy storage device that is the lead-acid battery, the controller 20 derives the SOC for the entire energy storage system 101 or each divisible unit by the algorithm for the lead acid battery, and derives the remaining life. The controller 20 may refer to data such as a purchase date and a maintenance inspection date from a customer information database, and determine whether the energy storage device can be safely used until a warranty period expires from the relationship between the remaining life of the energy storage device and the warranty period. When the power conditioning system P is included in the system or when the monitoring target device is the power conditioning system P, the controller 20 determines a consumption degree of a degraded component or the presence or absence of the sign of the abnormality. The controller 20 may also determine the life (consumption degree) of the uninterruptible power system U, the rectifier D, or the uninterruptible power system U and the rectifier D that are the monitoring target devices included in the system, and the presence or absence of the sign of the abnormality.

The controller 20 determines whether all the identification data are selected (step S312). When it is determined that all the identification data are not selected (NO in S312), the controller 20 returns the processing to step S301 and selects the next identification data.

When it is determined that all the identification data are selected (YES in S312), the processing ends.

According to the processing procedure in FIGS. 5 and 6, the controller 20 of the server device 2 holds information obtained by updating the communication abnormality, the abnormal state, or the attentional state and an analysis result periodically or according to the event for each monitoring target system or each monitoring target device. The client device 3 can appropriately request the information updated in the server device 2, display a list on the display unit 33, and present the information such that the operator can easily visually recognize the information.

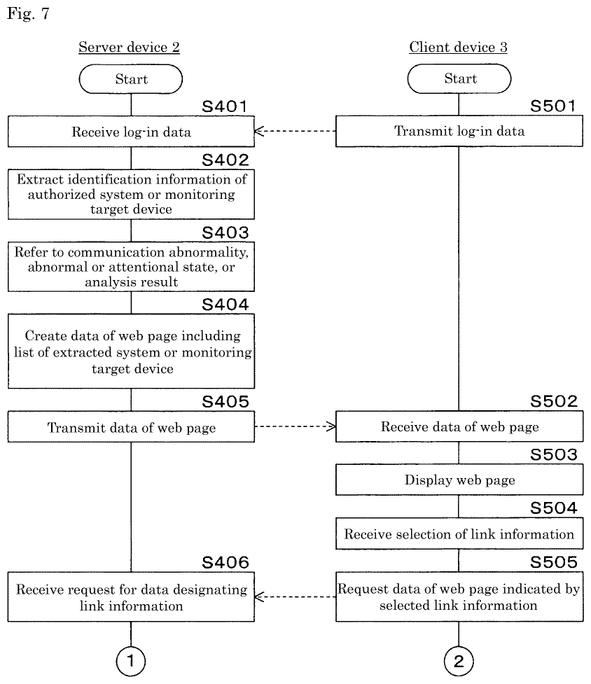

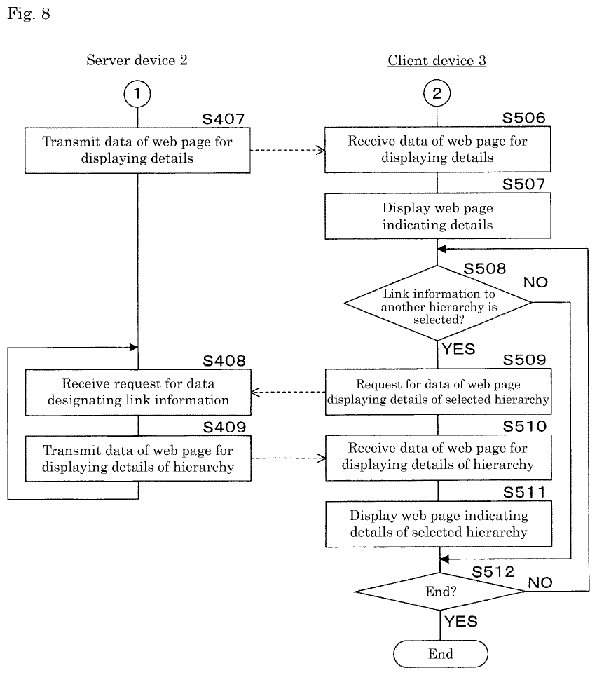

FIGS. 7 and 8 are flowcharts illustrating an example of a processing procedure of information presentation from the server device 2 to the client device 3. When the client device 3 receives a login request from the web browser, the server device 2 starts the following processing.

The controller 20 receives login data together with the login request from the client device 3 as the web server (step S401). In step S401, the controller 20 receives keys such as an ID and a password identifying the operator such as the maintenance worker or the manager who uses the client device 3. The controller 20 may receive biological information instead of the password.

Based on the received login data, the controller 20 extracts identification data of the system or the monitoring target device having access authority associated with an ID identifying the operator (step S402). In step S402, in the case where authentication of the received login data fails, the subsequent processing is omitted and the processing is ended.

The controller 20 refers to the communication abnormality, the detected abnormal or attentional state, and the analysis result held for the system or the monitoring target device identified by the extracted identification data (step S403).

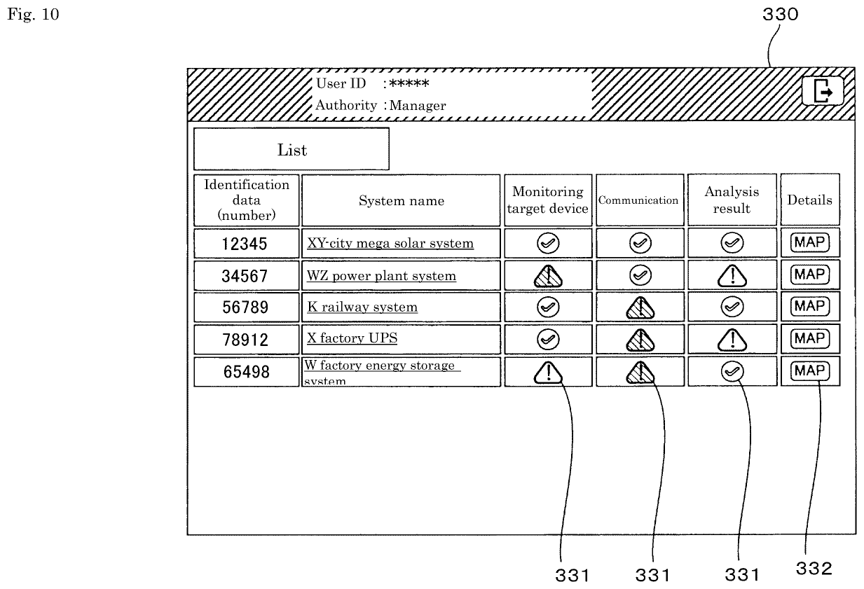

The controller 20 creates the data of the web page including a list of extracted systems or monitoring target devices based on design data such as a style sheet stored in the storage unit 21 (step S404). In step S404, the controller 20 creates the data of the web page so as to display an icon visually indicating the communication abnormality, the detected abnormal or attentional state, and the analysis result for each system or monitoring target device referred to in step S403 in association with the list. Specifically, for each system or monitoring target device, the controller 20 creates the screen information indicating the presence or absence of the abnormal or attentional detected in the monitoring target device, the presence or absence of the communication abnormality in the second communication path, the presence or absence of the communication abnormality in the first communication path, and the result of the analysis processing with the icon corresponding to the state. The screen also includes link information to a screen displaying detailed information enabling check of the state of each hierarchical structure of the energy storage device included in the system or the monitoring target device and the presence or absence of the abnormal or attentional state in each component in the power supply related device (see FIG. 10).

The controller 20 transmits the information about the created web page to the client device 3 that is the login request source (step S405).

After transmitting the login data by the communication unit 32 (step S501), the client device 3 receives the data of the web page including the list of systems or monitoring target devices having access authority (step S502). The controller 30 displays the web page on the display unit 33 (step S503).

As described above, the icon visually indicating the communication abnormality, the detected abnormal or attentional state, and the analysis result of each system or monitoring target device is collectively displayed on the web page displayed in step S503 in association with the list of the monitoring target systems or monitoring target devices. As a result, the operator such as the maintenance worker or the manager can visually check where the system or the monitoring target device is in the abnormal or attentional state and where the system or the monitoring target device is normal.

The displayed web page includes the link information displaying detailed information on each system or monitoring target device. The controller 30 receives the selection of the link information on the web page (step S504), and transmits a request for data of the web page indicated by the selected link information to the server device 2 (step S505).

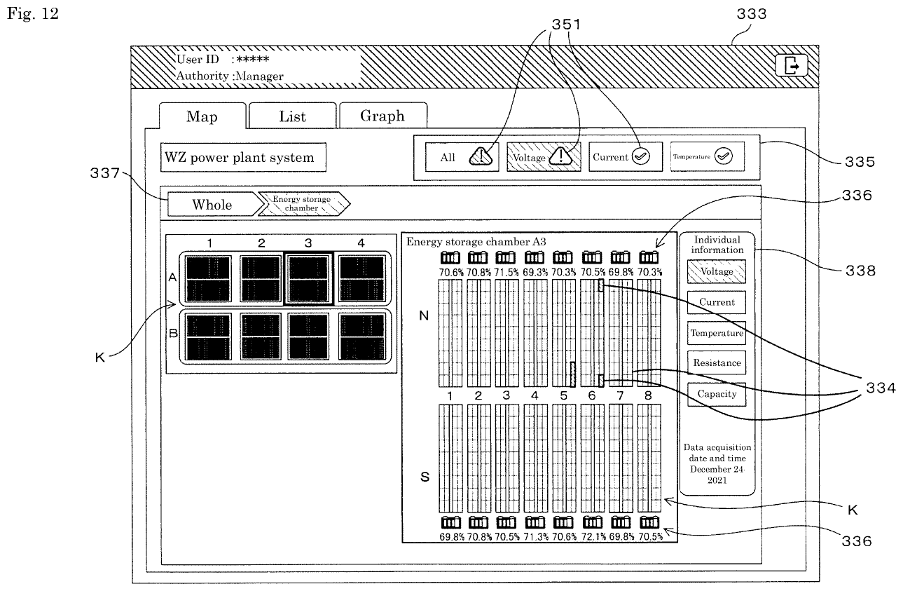

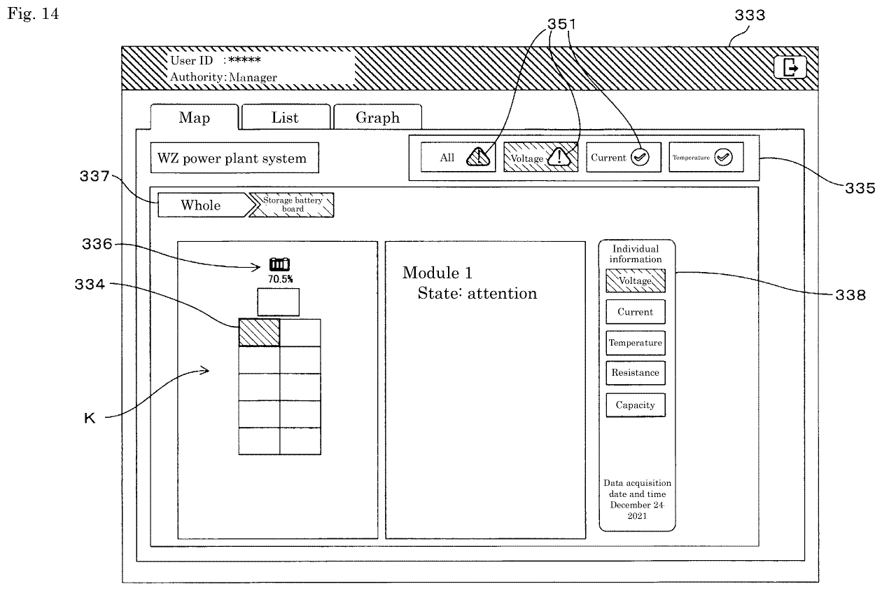

The controller 20 of the server device 2 receives the request for data designating the link information (step S406), and transmits the data of the web page for displaying details of the selected system or device to the client device 3 based on the link information (step S407). The processing of step S407 corresponds to the “transmission processing unit”. The data of the web page transmitted in step S407 has a configuration that can transition between hierarchies according to the hierarchical structure of the selected system or monitoring target device. Each web page includes an image indicating disposition of a position of the selected system or device in the building, a position in the container C, a position in a storage battery board, and the like and graphic data such as an illustration, an icon, an animation, and the like for expressing a state of each level. These graphics may be selectable by the operation unit 34. When the graphic is selected, the controller 30 causes the function of the web browser to transition to the web page in another hierarchy based on the link information associated with the graphic (see FIGS. 12 and 14). The controller 30 displays a numerical value of the measurement data for the device or the component in the screen by the script.

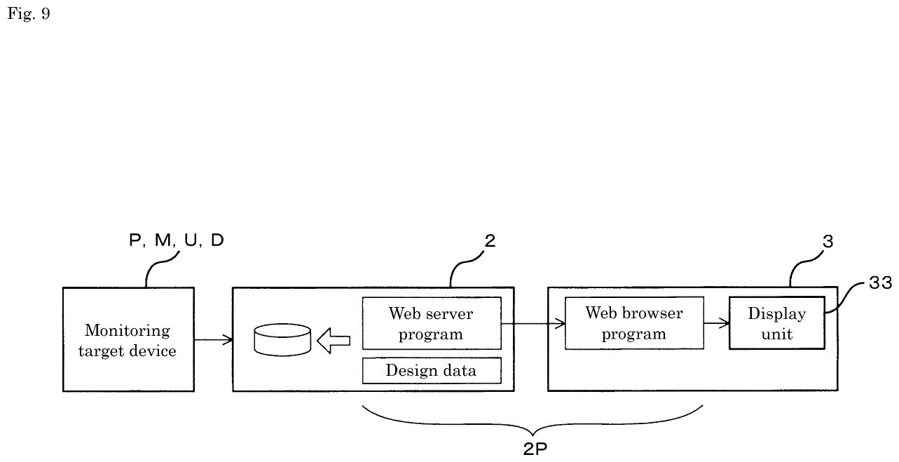

The controller 30 of the client device 3 receives the data of the web page (step S506), and displays the web page indicating details on the display unit 33 based on the received data (step S507). Thereafter, while the display of the web page in step S507 is maintained, based on the script (automatic update) included in the data of the web page, the controller 30 receives the state in the target hierarchy derived based on the measurement data of the selected system or monitoring target device or the detected state data from the server device 2, and updates and displays the state or the detected state data in the web page. FIG. 9 is a view illustrating a function of an automatic monitor unit 2P. As illustrated in FIG. 9, the state display is implemented by automatic update by the function of the automatic monitor unit 2P based on the cooperation between the web server program and the design data included in the server program 21P and the web browser program included in the client program 3P. The automatic monitor unit 2P may implement the transmission of the data to the client device 3 by https communication at intervals of, for example, 10 seconds or 15 seconds.

The controller 30 determines whether the link information to another hierarchy is selected on the web page indicating details of the target system or the monitoring target device (step S508). When it is determined that the link information is selected, for example, by selecting the graphic associated with the link information (YES in S508), the request for data of the web page for displaying details of the selected hierarchy is transmitted to the server device 2 based on the associated link information (step S509). When it is determined that the link information is not selected (NO in S508), the controller 30 advances the processing to step S512.

The controller 20 of the server device 2 receives the data request designating the link information (step S408), and transmits the data of the web page for displaying the details of the selected hierarchy to the client device 3 based on the link information (step S409). The controller 20 transmits the data of the web page (S409) every time the request for data specifying the link information is received (S408) until the end operation of displaying the web page is performed in the client device 3.

The controller 30 of the client device 3 receives the data of the web page indicating the details of the selected hierarchy (step S510). The controller 30 causes the display unit 33 to display the web page indicating the details of the selected hierarchy (step S511). Also in step S511, as illustrated in FIG. 9, while the display of the web page is maintained, the controller 30 receives the state in the target hierarchy derived based on the measurement data of the selected hierarchy from the server device 2 based on the script (automatic update) included in the data of the web page of the selected hierarchy, and updates and displays the state in the web page.

The controller 30 determines whether the operation ending the display of the web page of the target system or monitoring target device is accepted (step S512), and when it is determined that the operation is not accepted (NO in S512), the processing returns to step S508. In step S512, the controller 30 may determine that the end operation is received when the web browser is ended, logout is selected, or the transition to the web page displayed in step S502 is selected.

When it is determined that the end operation is received (YES in S512 ), the controller 30 ends the information presentation processing.

In the processing procedures illustrated in FIGS. 7 and 8, it has been described that the web page for displaying the information of the system or the monitoring target device includes the script for the automatic update, and the state in each layer is automatically updated (also referred to as the automatic monitoring function). Every time the web page is automatically updated, the server device 2 updates the content of the web page according to the state and the result of the analysis processing for each hierarchy derived periodically or according to the event according to the procedure in FIG. 6. Alternatively, the state update may be configured such that an update request is transmitted from the client device 3 to the server device 2 each time the operator operates the operation unit 34 of the client device 3 to select another layer or the uppermost layer. In this case, in response to an event that the update request is received, the server device 2 may derive the state for each hierarchy and perform analysis processing on the target system according to the procedure in FIG. 6, or may periodically transmit derived data.

A specific example of the web page presented by the server device 2 will be described with reference to the drawings. FIGS. 10 to 14 are views illustrating a specific example of the web page presented by the server device 2. FIG. 10 illustrates a web screen (the screen displayed on the display unit 33 of the client device 3) 330 illustrating the list of systems or monitoring target devices authorized for the logged-in operator. In the example of FIG. 10, a name “XY city mega solar system” of the mega solar power generating system S in FIG. 1, a name “WZ power plant system” of the wind power generating system W, other systems “K railway system”, “X factory UPS”, “W factory power storage system”, and the like are displayed as the list.

The web screen 330 of FIG. 10 includes icons 331 indicating states for the respective items of “monitoring target device”, “communication”, and “analysis result” for the system and the monitoring target device. The icon 331 in the item of “monitoring target device” indicates whether the monitoring target device in the system and the single monitoring target device detect the abnormal or attentional state. The icon 331 in the item of “communication” indicates whether the server device 2 detects the abnormality in the first communication path, namely, the communication between the server device 2 and the communication device 1 included in the system and the monitoring target device. The icon 331 in the item of “analysis result” indicates an execution result of the analysis processing by the server device 2 based on the measurement data for the system and the monitoring target device.

In FIG. 10, the icons 331 represent three of “abnormal”, “attentional”, and “normal (no problem)”. For example, in the “XY city mega solar system”, the icons 331 of the items of “monitoring target device”, “communication”, and “analysis result” are all “normal”. That is, in the “XY city mega solar system”, the abnormality or attention is not detected in the monitoring target device, the communication device 1, or the server device 2. In the “WZ power plant system”, the icon 331 of the item of “monitoring target device” represents “abnormal”, the icon 331 of the item of “communication” represents “normal”, and the icon 331 of the item of “analysis result” represents “attentional”. That is, the “WZ power plant system” indicates that the abnormality is detected in the monitoring target device, that the communication between the server device 2 and the communication device 1 is normal, and that the server device 2 determines that the attention should be paid to the monitoring target device. In the “K railway system”, the icons 331 of the items of “monitoring target device” and “analysis result” represent “normal”, and the icon 331 of the item of “communication”represents “abnormal”.

The operator can distinguish and recognize whether the abnormality is detected in the monitoring target device or the communication abnormality is generated in each system or monitoring target device by the web screen 330 displayed by performing the login operation. The operator can use the web screen 330 to distinguish a failure generated on site in terms of where the failure is caused. On the web screen 330, even when neither the abnormality nor the attention state is detected in the monitoring target device and the communication device 1 at the time of checking the screen, the operator can recognize that a sign of the abnormality is detected from the analysis result of the server device 2. The server device 2 performs the analysis suitable for the type of the energy storage device or the power supply related device included in the system or the monitoring target device. The operator can check the result of the abnormality detection by different approaches to the system or the monitoring target device on the web screen 330 without performing many operations. In addition, for the communication abnormality, an abnormal portion can be distinguished between the communication abnormality between the monitoring target device and the communication device 1 and the communication abnormality between the communication device 1 and the server device 2.

On the web screen 330 in FIG. 10, an “MAP” icon 332 is displayed in association with each system or monitoring target device. The “MAP” icon 332 is associated with the link information to the screen illustrating the details of the target system or monitoring target device. In the case where the link information is selected, the controller 30 of the client device 3 designates the link information and requests the web page indicating the details of the system or the monitoring target device from the server device 2.

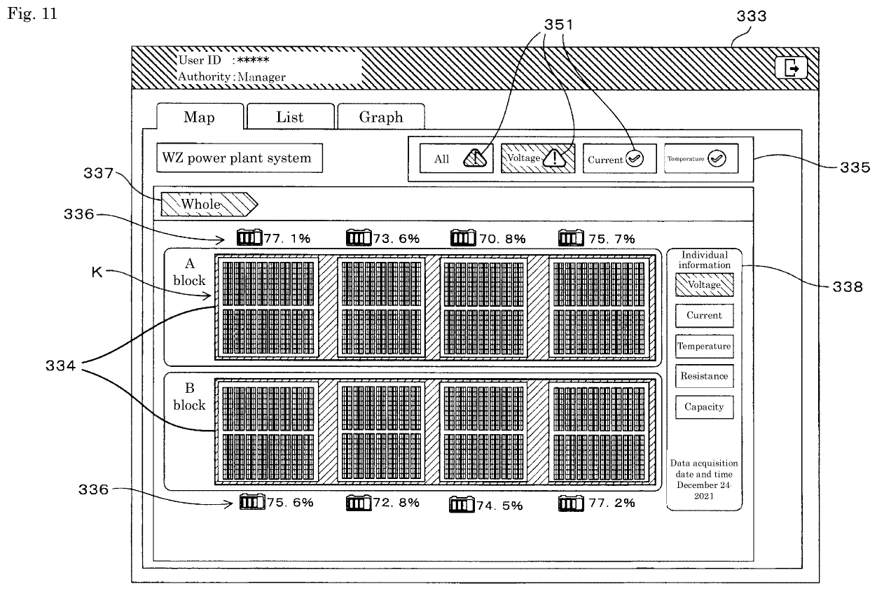

FIG. 11 illustrates an example of a screen 333 in the case where the “MAP”icon 332 of the system or the monitoring target device is selected.

The screen 333 in FIG. 11 is displayed in the case where the “WZ power plant system” in the list of the systems or the monitoring target devices in FIG. 10 is selected by the operation of the operation unit 34 of the client device 3. The screen 333 includes a layout image K (a diagram such as a CAD diagram, or a photograph) indicating the disposition of a large number of energy storage module groups L. The screen 333 in FIG. 11 illustrates a configuration and a state of the system in an uppermost layer of the hierarchical structure of the “WZ power plant system”. The screen 333 in FIG. 11 includes the layout image K of the entire eight energy storage chambers constituting the “WZ power plant system”. The layout image K in FIG. 11 illustrates the storage battery board that stores three banks configuring the domain with one small rectangle. The screen 333 includes a graphic object 334 that visually represents the state of the “WZ power plant system”along with the layout image K.

The graphic object 334 is a graphic that is superimposed on the layout image K of the system and indicates the state of the energy storage device disposed at the place. The color and display form of the graphic object 334 may be varied according to the state (abnormal/caution/normal) of the entire system on which the graphic object 334 is superimposed.

The screen 333 includes a display item field 335. In the example of FIG. 11, the display item field 335 includes four types of icons of “all”, “voltage”, “current”, and “temperature”. The screen 333 includes an individual information field 338 that individually switches the unit of state display in each hierarchy. The individual information field 338 includes buttons that select units such as voltage, current, temperature, resistance, and capacity. When the unit is selected in the individual information field 338, which one of “voltage”, “current”, and “temperature” is selected is indicated in the button and display item field 335 of the individual information field 338. When the unit is selected in the individual information field 338, the graphic object 334 displays the presence or absence of the abnormal or attentional state and the degree of abnormality in the unit for the measurement data. In FIG. 11, “voltage”is selected. When the “voltage” button is selected in the individual information field 338, the screen 333 displays the state in the “voltage” item, namely, whether the voltage is abnormal, with the color or display mode of the graphic object 334 superimposed on the rectangle corresponding to each monitoring target device (energy storage device).

The “all” item in the display item field 335 can be selected. When the “all” item is selected, the screen 333 displays the states of communication items of the “voltage”, “current”, and “temperature” in the color and display form of the graphic object 334. The screen 333 displays the state based on different measurement data while the same layout image K is used by the operations of the individual information field 338 and the display item field 335.

In the individual information field 338, while a graphic object 336 displays the information in units of banks, the value of the selected unit among the voltage, current, and temperature of the unit of the storage battery board represented by the small rectangle on the layout image K in FIG. 11 is displayed by text or the like. In the case where the operator selects “voltage” in the individual information field 338, when the operator selects the small rectangle on the screen 333 using the operation unit 34, the total voltage or the average voltage of the selected small rectangular storage battery board is displayed in or around the small rectangle.

In each of the buttons or icons of “all”, “voltage”, “current”, and “temperature” in the display item field 335 in FIG. 11, an icon 351 indicating the state determined from the viewpoint of each item is displayed. For example, “All” includes a communication state other than voltage, current, and temperature. The “communication state” on the screen 333 illustrating the details of the system or the monitoring target device indicates the communication state on the second communication path, namely, the state of communication between the monitoring target device and the communication device 1, and can be distinguished from the communication abnormality illustrated by the web screen 330 in FIG. 10. That is, the communication between the communication device 1 and the server device 2 is normal, so that real-time detailed information can be displayed on the screen 333. However, when the communication abnormality exists between the communication device 1 and each monitoring target device, the real-time detailed information is individually displayed on the screen 333.

The icon 351 represents three of “abnormal”, “attentional”, and “normal (no problem)”. In the example of FIG. 11, the icon 351 indicating the state of “abnormal” is displayed for the button of “all”, and the icon 351 indicating the state of “attentional” is displayed for the button of “voltage”. The icon 351 of “normal” is displayed on the buttons of “current” and “temperature”.

The screen 333 in FIG. 11 includes the graphic object 336 indicating the SOC of the energy storage device included in the system. The graphic object 336 may indicate the SOC (the total SOC of a plurality of modules or banks) of a plurality of modules, a plurality of banks, or a plurality of domains as one evaluation unit. On the screen 333 in FIG. 11, the SOC value of the evaluation unit is displayed along the graphic object 336. For example, the SOC value is calculated based on the SOC value calculated for each bank to which the plurality of modules are connected. For example, the SOC value is a value calculated as an average value.

With the information presentation such as the screen 333 in FIG. 11, even for the large-scale ESS including an enormous number of modules, the operator who checks the screen 333 can grasp the entire situation by the layout image K and the graphic objects 334, 336.

The screen information describing the screen 333 includes a script transitioning to the display of the state of the lower layer when the module, the bank, or the domain (that is, it is a selection target in the layout image K and may be the same as the evaluation unit of the SOC) in the layout image K is selected.

The screen 333 may include a hierarchical menu 337 that displays the hierarchy of energy storage system 101. In FIG. 11, the hierarchical menu 337 indicates the hierarchy of “whole” corresponding to the uppermost layer. The hierarchy in the hierarchical menu 337 includes the link information returning to the screen 333 of the upper layer each time the hierarchy transitions from the uppermost layer to the lower layer.

FIG. 12 is a view illustrating an example of the screen 333 that transitions to the state display of another layer. FIG. 12 is displayed on the web browser of the client device 3 by the automatic monitor unit 2P when a portion (for example, a portion corresponding to the third energy storage chamber from the left of the A block) corresponding to one of the energy storage chambers is selected on the layout image K in FIG. 11. In FIG. 12, the screen 333 includes the reduced layout image K of the entire upper layer before the transition on the left side of the screen, and includes a layout image K of the selected energy storage chamber on the right side. In the screen 333 of FIG. 12, which position of the selected energy storage chamber on the entire map of the upper layer is indicated by emphasis on the reduced layout image K of the upper layer. In the example of FIG. 12, the position of the selected energy storage chamber is emphasized by a rectangular object on the layout image K of the upper layer. Alternatively, the position in the upper layer may be indicated by changing the color of the corresponding portion on the layout image K of the upper layer or superimposing an object.

In the example of FIG. 12, the screen 333 after the transition includes the layout image K indicating the energy storage module group L in units included in the energy storage chamber. A small rectangle corresponding to the minimum unit included in the screen 333 of FIG. 12 corresponds to the storage battery board that stores three banks. In the layers below the layer indicated by the screen 333 in FIG. 12, the color and display form of the graphic object 334 may be made different for the module group L in the abnormal state according to the degree of the abnormal or attentional state.

Also in the example of FIG. 12, the screen 333 includes the display item field 335 of the display content to which the icon 351 is attached. Also in the hierarchy of FIG. 12, the operator can visually determine which of the items “all”, “voltage”, “current”, and “temperature” is abnormal/attentional/normal.

With the information presentation illustrated in the screen 333 of FIGS. 11 and 12, the layout image K and the graphic object 334 allow the operator to grasp the details of which treatment is required at which place and at what degree of urgency for the large-scale ESS including an enormous number of modules.

When a portion corresponding to any unit is selected on the layout image K on the screen 333 in FIG. 12, the screen 333 transitions to a screen (not illustrated) largely indicating the layout image K of the unit. When a portion corresponding to any one of the storage battery boards is selected on the layout image K of the unit, the screen 333 further transitions to a screen (not illustrated) largely indicating the layout image K of the storage battery board. As described above, when the “MAP” icon 332 is selected on the web screen 330 including the list of the systems or the monitoring target devices in FIG. 10, the client device 3 displays the screen 333 that can transition according to the hierarchical structure of the system or the monitoring target device and illustrates the state in each hierarchy in detail.

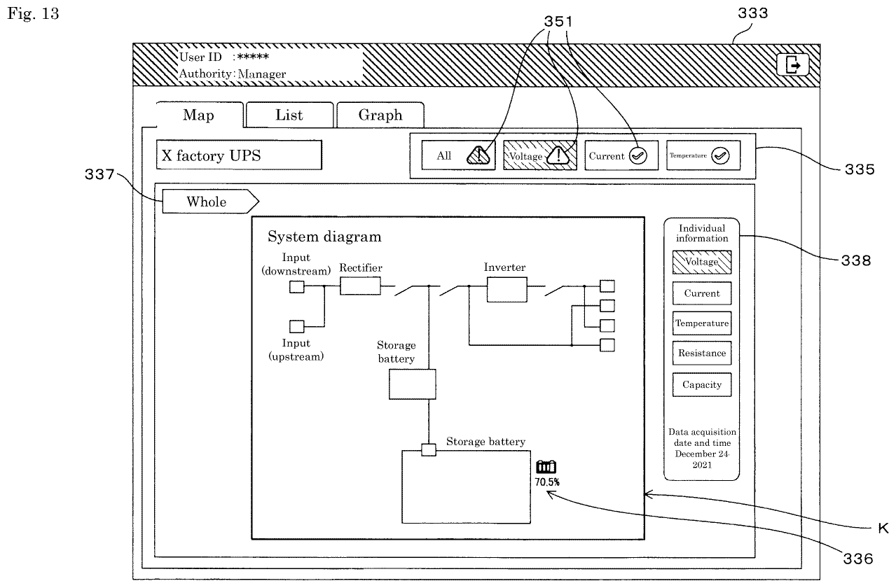

FIG. 13 illustrates another example of the screen 333 in the case where the “MAP” icon 332 of the system or the monitoring target device is selected. The screen 333 in FIG. 13 is displayed when the monitoring target device “X factory UPS” in the list of the systems or the monitoring target devices in FIG. 10 is selected by the operation of the operation unit 34 of the client device 3. The screen 333 includes the layout image K (diagram) illustrating the configuration of the uninterruptible power system U named “X factory UPS”. The screen 333 in FIG. 13 illustrates the entire system of the “X factory UPS”. The layout image K on the screen 333 includes the diagram (circuit diagram) of a circuit constituting the “X factory UPS” and a block indicating the energy storage device. The screen 333 includes the graphic object 334 that visually represents the state of the “X factory UPS” together with the layout image K.

Also in FIG. 13, the graphic object 334 included in the screen 333 illustrating the details of the system or the monitoring target device illustrates the states of the components and energy storage devices disposed at the place. Also in the example of FIG. 13, the screen 333 includes the script transitioning to the display of the state of the lower layer (more detail) when the circuit or the energy storage device in the layout image K of the uninterruptible power system U is selected.

Also in the example of FIG. 13, the screen 333 includes the display item field 335 of the display content to which the icon 351 is attached. The operator can visually determine whether the monitoring target device used alone is abnormal/caution/normal in any of the items of “all”, “voltage”, “current”, and “temperature”.

FIG. 14 is a view illustrating an example of the screen 333 that transitions to the state display of another layer. In FIG. 14, when the block of the energy storage device is selected on the layout image K in FIG. 13, the block is displayed on the web browser by the automatic monitor unit 2P.

The screen 333 in FIG. 14 includes the layout image K of the selected energy storage device on the left side of the screen, and the details of the target (module) selected in the layout image K on the left side are illustrated on the right side of the screen. In FIG. 14, the energy storage device is the storage battery board including the plurality of modules. The layout image K indicates the modules included in the storage battery board in the rectangular shape. In FIG. 14, the controller 30 of the client device 3 displays that the selected module is in the attentional state on the right side of the screen 333. In addition, a detailed description of the configuration of the module may be displayed on the right side.

Also in the example of FIG. 14, the screen 333 includes the display item field 335 of the display content to which the icon 351 is attached. As illustrated in FIG. 14, for each hierarchy, the operator can visually discriminate which of the items “all”, “voltage”, “current”, and “temperature” is abnormal/caution/normal.

The screen 333 of the monitoring target device used alone in FIG. 14 also includes the individual information field 338. The individual information field 338 displays specific numerical values such as voltage, internal resistance, temperature, and current of the energy storage device in the layer corresponding to any rectangle (for example, the module) on the layout image K.

As illustrated in FIG. 14, even when the monitoring target device used alone is the target, the operator can be caused to grasp the details of what kind of treatment is required at what degree of urgency in which portion in the device by the layout image K of the device and the graphic object 334 by the information presentation illustrated in the screen 333.

### Second Embodiment

In a second embodiment, the server device 2 presents the screen capable of identifying whether the state of the monitoring target system or the state of the monitoring target device is the state of the device or component included in the system or the monitoring target device.

A configuration of the remote monitoring system 100 of the second embodiment is similar to that of the first embodiment except for details of processing in the server device 2 described below. In the configuration of the remote monitoring system 100 of the second embodiment, the same reference numerals are given to the configuration common to the remote monitoring system 100 of the first embodiment, and the detailed description is omitted.

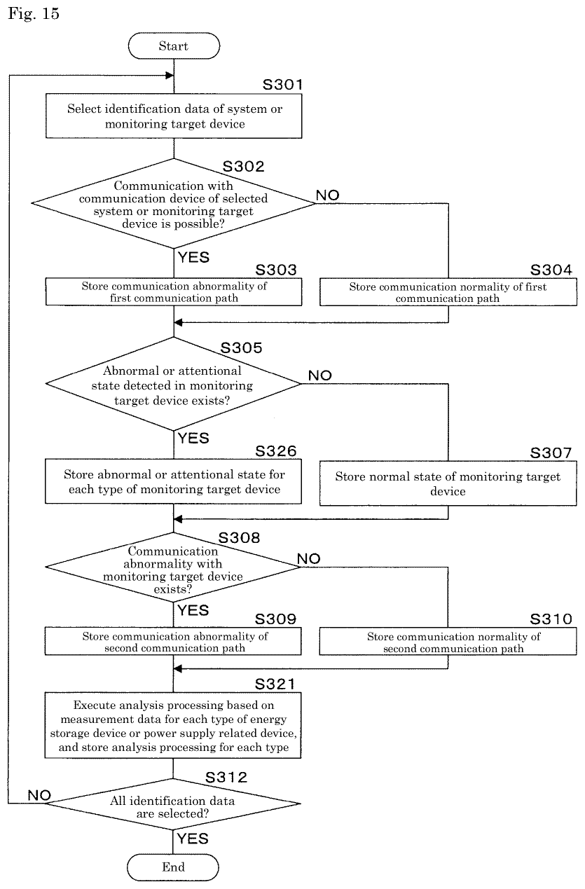

FIG. 15 is a flowchart illustrating an example of an information processing procedure in the server device 2 of the second embodiment. The procedure common to the processing procedure in FIG. 6 is denoted by the same step number, and the detailed description thereof is omitted.

In the second embodiment, when it is determined that the abnormal or attentional state detected in the monitoring target device (YES in S305), the controller 20 of the server device 2 temporarily stores the abnormal or attentional state in the monitoring target device for each type of monitoring target device in association with the identification data selected in step S301 (step S326). The state data transmitted from the communication device 1 when the abnormal or attentional state is detected is associated with the identification data of the monitoring target device of the monitoring target (see S202). For this reason, in step S326, the controller 20 can determine whether the monitoring target device in which the state data is detected is the energy storage device, the power conditioning system P, the uninterruptible power system U, or the rectifier D based on the identification data of the monitoring target device and the configuration data of the monitoring target system or monitoring target device stored in server device 2.

After executing the processing (S309, S310) according to the result of determining whether the communication abnormality with the monitoring target device exists in step S308, the controller 20 executes the analysis processing based on the measurement data accumulated in the storage unit 21 by the algorithm for each type, and stores the analysis result separately for each type (step S321).

According to the processing procedure of the second embodiment, the controller 20 of the server device 2 holds the information obtained by updating the communication abnormality, the abnormal state or the attentional state, and the analysis result periodically or according to an event for each monitoring target system or each monitoring target device while dividing the information into types of monitoring target devices. The client device 3 can appropriately request the information updated in the server device 2, display the list on the display unit 33, and present the information such that the operator can easily visually recognize where and what kind of abnormality is generated in the first web screen 330.

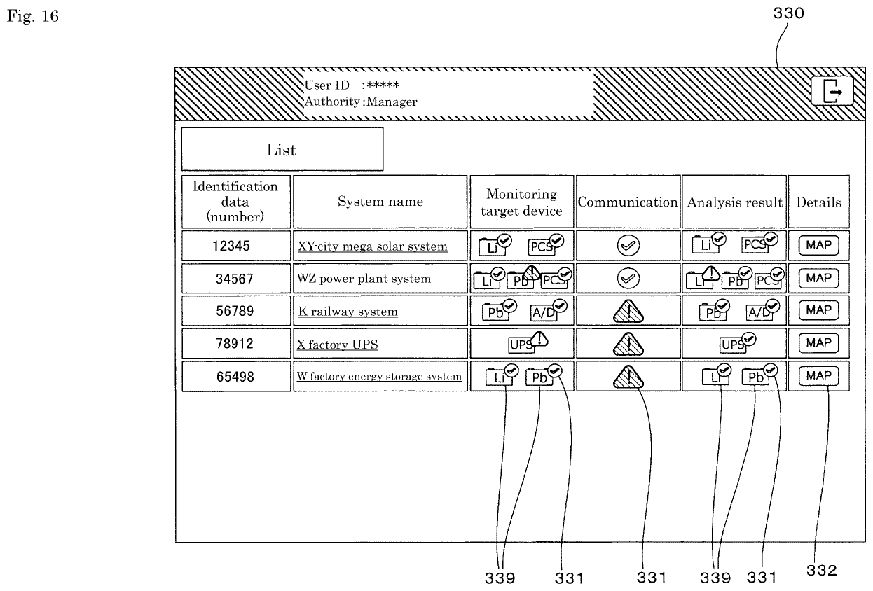

FIG. 16 is a view illustrating a specific example of the web page presented by the server device 2. The web screen 330 illustrating the list of systems or monitoring target devices authorized for the logged-in operator is illustrated. The web screen 330 displayed on the client device 3 in the second embodiment includes the icons 331 indicating states for the respective items of “monitoring target device”, “communication”, and “analysis result”for each of the system and the monitoring target device. The icon 331 in the item of “monitoring target device” distinguishes whether the abnormal or attentional state is detected in the monitoring target device or any one of the monitoring target devices in the system. The icon 331 may be distinguished for each component when the component to be distinguished exists in the monitoring target device used alone. The icon 331 in the item of “analysis result” indicates the execution result of the analysis processing by server device 2 based on the measurement data for the system and the monitoring target device while the target monitoring target devices are distinguished.

In FIG. 16, an icon 339 identifying the type of the monitoring target device or the monitoring target device included in the system, namely, the energy storage device, the power conditioning system P, the uninterruptible power system U, the rectifier D, and the like is displayed in the items of “monitoring target device” and “analysis result” in the list. The icons 331 indicating three of “abnormal”, “attentional”, and “normal (no problem)” are displayed in the vicinity of the icon 339 indicating the type of the monitoring target device.

In FIG. 16, for example, the “XY-city mega solar system” includes the energy storage system 101 including the lithium ion battery and the power conditioning system P, and the icons 331 of items of “monitoring target device”, “communication”, and “analysis result” are all “normal”. The “WZ power plant system” includes the energy storage system 101 including both the lithium ion battery and the lead acid battery and the power conditioning system P, and it is indicated that the attentional state is detected in the energy storage system 101 of the lead-acid battery. The web screen 330 indicates that the server device 2 determines that the attention should be paid to the lead-acid battery included in the “WZ power plant system”. The “K railway system” includes the energy storage system 101 of the lead-acid battery and the rectifier D. The icon 331 in each of the items of “monitoring target device” and “analysis result” indicates “normal”, and the icon 331 in the item of “communication”indicates “abnormal”.

As described above, with the web screen 330 of the second embodiment, the operator can recognize, in detail, whether the abnormality is detected in the monitoring target device itself or whether the communication abnormality is generated in each system or monitoring target device. The operator can use the web screen 330 to classify the failure generated on site into which device the failure is generated.

The embodiments disclosed as described above are illustrative in all respects and are not restrictive. The scope of the present invention is illustrated by the scope of the claims, and includes all changes within the scope of the claims and meaning equivalent to the scope of the claims.

### DESCRIPTION OF REFERENCE SIGNS

1: communication device
10: controller
2: server device (information processing device)
20: controller
21: storage unit (storage medium)
3: client device
30: controller
33: display unit
330: web screen
333: screen
331, 332, 339: icon

1. An information processing device comprising:
an acquisition unit that acquires state data indicating a state of a monitoring target device from a communication device of the monitoring target device, which is an energy storage device or a power supply related device, or from a communication device of a system including a plurality of the monitoring target devices by communication;
a storage processing unit that stores the acquired state data in a storage medium in association with identification data of the monitoring target device or the system; and
a transmission processing unit that transmits, in response to a request from an outside or as an event, display information collectively displaying the state data stored in the storage medium and a communication state with the communication device while the state data and the communication state are distinguished from each other for each monitoring target device or system.

2. The information processing device according to claim 1,
wherein the acquisition unit acquires the measurement data of each of the monitoring target devices,
the information processing device further comprising an analysis processing unit that analyzes presence or absence of an abnormality or a sign of the abnormality of the monitoring target device or system by an algorithm for each monitoring target device or system based on acquired measurement data,
wherein the transmission processing unit transmits display information, which displays an analysis result by the analysis processing unit while the state data and the communication state are distinguished from each other, for each monitoring target device or system.

3. The information processing device according to claim 2, wherein the display information is information distinguishing and displaying an analysis result for any monitoring target device included in the monitoring target device or system.

4. The information processing device according to claim 3, wherein the display information is information distinguishing at which portion included in the monitoring target device or system a state is detected, and displaying the state of the monitoring target device or system detected.

5. The information processing device according to any one of claims 1 to 4, wherein the display information is information collectively displaying a graphic visually indicating the state data and the communication state at a corresponding portion of a list of the monitoring target devices or systems.

6. The information processing device according to any one of claims 1 to 5, wherein the display information includes information transitioning to a screen that displays detailed information about a part included in the monitoring target device or system, or about the monitoring target device according to a hierarchical structure of the monitoring target device or system for each monitoring target device or system.

7. An information processing device comprising:
an acquisition unit that acquires state data indicating a state of a monitoring target device from a communication device of the monitoring target device, which is an energy storage device or a power supply related device, or from a communication device of a system including a plurality of the monitoring target devices by communication; and
a transmission processing unit that transmits, in response to a request from an outside or as an event, for each of the monitoring target devices or systems, display information displaying a communication state between the information processing device and the communication device and a communication state between the communication device and the monitoring target device while the communication state between the information processing device and the communication device and the communication state between the communication device and the monitoring target device are distinguished from each other.

8. An information processing system comprising:
a plurality of communication devices that are mounted on or connected to a monitoring target device, which is an energy storage device or a power supply related device, or a system including a plurality of monitoring target devices;
an information processing device that is capable of establishing communication connection with the plurality of communication devices; and
a client device that includes a display unit capable of establishing communication connection with the information processing device,
wherein the information processing device:
sequentially acquires state data indicating a state of the monitoring target device from the plurality of communication devices;
stores the acquired state data in a storage medium in association with identification data of the monitoring target device or system;
creates display information collectively displaying the state data stored in the storage medium and a communication state with the communication device in response to a request from an outside or as an event while distinguishing the state data and the communication state from each other for each monitoring target device or system; and
transmits the created display information to the client device.

9. An information processing method comprising:
sequentially acquiring state data indicating a state of a monitoring target device from a communication device of the monitoring target device, which is an energy storage device or a power supply related device, or from a communication device of a system including a plurality of the monitoring target devices by communication;
storing the acquired state data in a storage medium in association with identification data of the monitoring target device or the system; and
transmitting, in response to a request from an outside or as an event, display information collectively displaying the state data stored in the storage medium and a communication state with the communication device while distinguishing the state data and the communication state from each other for each monitoring target device or system.

10. A computer program causing a computer capable of establishing communication connection with a communication device of a monitoring target device, which is an energy storage device or a power supply related device, or with a communication device of a system including a plurality of the monitoring target devices by communication to execute:
acquiring sequentially state data indicating a state of the monitoring target device from the communication device of the monitoring target device or the communication device of the system;
storing the acquired state data in a storage medium in association with identification data of the monitoring target device or system; and
transmitting, in response to a request from an outside or as an event, display information collectively displaying the state data stored in the storage medium and a communication state with the communication device while distinguishing the state data and the communication state from each other for each monitoring target device or system.
